(19) United States
(12) Patent Application Publication
(10) Pub. No.: US 2007/0224972 A1
(43) Pub. Date: Sep. 27, 2007

(54) System and method to reduce key presses for sending messages

(76) Inventor: Mark A. Van Regenmorter, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/370,300

(22) Filed: Mar. 8, 2006

(51) Int. Cl. H04L 12/58

(52) U.S. Cl. 455/412.1; D14/300; D14/314

(57) ABSTRACT

A system and method for creating text messages are disclosed. The system and method comprise an electronic device configured for text message use; a plurality of indicia used to create a text message on the electronic device; a plurality of keys located on the electronic device and associated with the plurality of indicia, wherein the indicia located on the keys are arranged in part according to the frequency of use of the indicia on the key; an indicium selection feature, where at least one indicium is selected by pressing at least one key with which it is associated the number of times matching the order with which the indicia appears on the key; and a message sending feature available on the electronic device, where the message created by the selection of the indicium is sent.

### BACKGROUND OF THE INVENTION

1. Field of the Invention

The invention relates to improving text messaging capabilities of electronic devices. More particularly, the invention relates to reducing the number of key presses for sending messages from electronic devices capable of text messaging.

2. Description of the Related Art

Electronic devices that are capable of text messaging allow for the creation of messages comprised of text as a result of pressing keys associated with characters. One service often available to electronic devices capable of text messaging is the Short Message Service (“SMS”). SMS is a service that permits the sending of short messages between mobile telephones, landline telephones, and other electronic devices. Other examples of SMS use include ordering services and entering contests.

Text messages are often used in place of a telephone call when making a call would be either inconvenient or inappropriate. In order to create a text message in most prior art systems, a user would need to enter the electronic device's text messaging mode. Upon entry into text messaging mode, a user may select a character to be used in the message by pressing the key upon which that character appears the number of times equal to the character's order on the key. For example, in the prior art, the key number “3” is associated with characters “D” “E” and “F.” Consequently, if a user would like to use the character “E,” the user would need to press the “3” key two times. When the user has selected all of the characters or symbols needed to create his message and is satisfied, the user may send the message via SMS if the electronic device has that feature.

Conventional approaches of associating indicia with keys do not take into account the frequency with which the indicia are used. For example, it is generally agreed that in the English language vowels are more frequently used than consonants. The conventional arrangement of vowels in text messaging devices requires more than one key press for all but one vowel, ‘A,’ where lower frequency consonants appear before the higher frequency vowels. Consequently, it takes longer to select higher frequency indicia such as vowels than lower frequency indicia when attempting to create a text message.

### SUMMARY OF THE INVENTION

Thus, it would be advantageous to develop a method and system for reducing the number of key presses required for creating a text message. One aspect disclosed herein provides a method and system for reducing the number of key presses required for creating a text message by arranging indicia for use in text messages on keys according to their frequency of use. Indicia may include characters, such as alphanumeric or non-alphanumeric characters, words, phrases, sentences, or any other string. Indicia on the keys may be accessed in any number of ways, including by pressing a key the number of times equaling the order with which the desired indicium appears on the key, or pressing and holding the key until the desired indicium is accessed.

Consequently, in certain embodiments, text messages may be created more quickly because more frequently used indicium are more quickly accessible. For example, in certain embodiments discussed herein, vowels are the first indicium to appear on their keys compared to lower frequency consonants, so the vowels are more quickly accessible when creating a text message.

Neither this summary nor the following detailed description purports to define the invention. The invention is defined by the claims. For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

These and other features will now be described with reference to the drawings summarized below. These drawings and the associated description are provided to illustrate a preferred embodiment of the invention, and not to limit the scope of the invention.

FIG. 1 schematically illustrates a network environment in which embodiments of the invention can be implemented.

FIG. 2 is a block diagram of a shared network device capable of text messaging in accordance with an embodiment.

FIG. 3 shows an embodiment of the system using only numbered keys from a telephone pad and alphanumeric characters.

FIG. 4 shows a text messaging key system according to the prior art.

FIG. 5 shows an embodiment of the system using non-alphanumeric characters and all available telephone pad keys.

FIG. 6 shows an embodiment of the system where words, phrases and sentences are included on the keys in addition to alphanumeric characters.

FIG. 7 is a flowchart of the selection of characters for display in association with keys in accordance with one embodiment.

FIG. 8 is a flowchart of how a text message may be sent in accordance with one embodiment.

### DETAILED DESCRIPTION OF THE PREFERRED EMBODIMENT

The present invention provides improved usage of text messaging systems by reducing the number of key presses required to select commonly used characters. In certain embodiments discussed herein, the number of total key presses to create a text message would be reduced for most words because each key would require no more than three presses to access a character. In certain embodiments, the system would allow vowels to be accessed by the first key press because they are the first characters on their respective keys. Although in certain embodiments discussed herein the indicium are referred to as being on the keys, the indicium may also be off of the keys, such that an association between the indicium and keys may still be inferred.

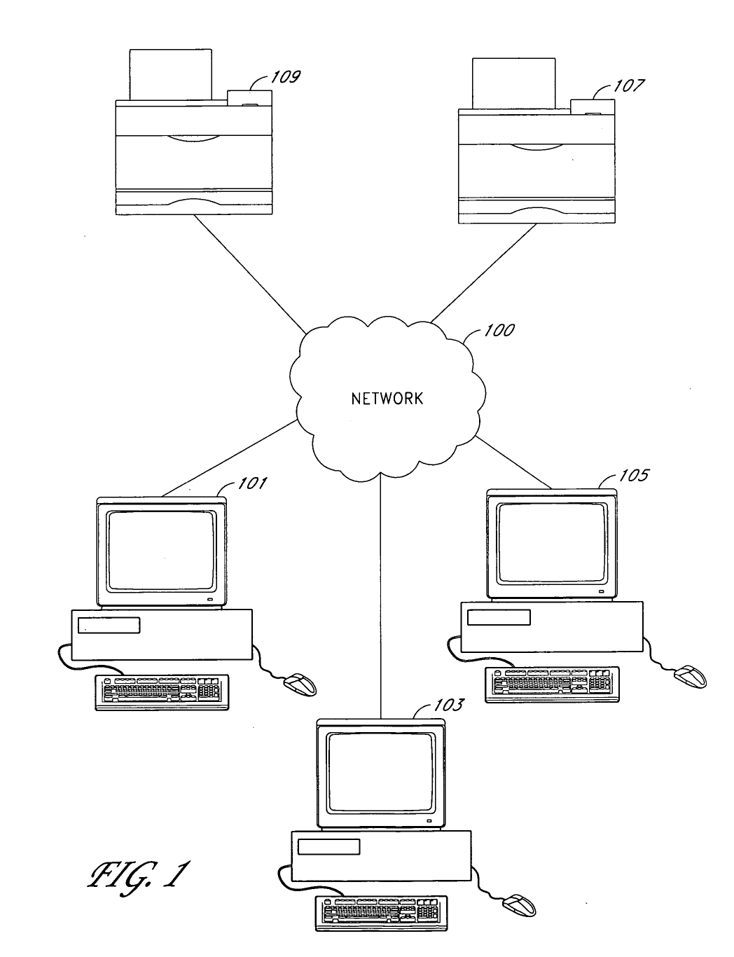

FIG. 1 illustrates a sample network environment in which an embodiment of the invention can be implemented. In the illustrated embodiment, networked computing devices 101, 103, 105 and network devices 107, 109 are connected to the network 100. In this network environment, users of the networked computing devices 101, 103, 105 can share the network devices 107, 109. In other words, the users of the networked computing devices 101, 103, 105 can access the network devices 107, 109 via the network 100 and process certain tasks using the network devices 107, 109 even though these devices are not locally connected to the networked computing devices 101, 103, 105.

In the illustrated embodiment, the network 100 can be any form of information network interconnecting various computers, computerized devices and network devices. The network 100 may have either or both wired and wireless connections. The networked computing devices 101, 103, 105 represent any computerized devices that can provide commands to another device, e.g. printers connected to the network 100. Such computerized devices include, for example, desktop computers, laptop computers, network servers, handheld computers, smartphones, etc. The network devices 107, 109 represent any devices that can be shared by the networked computing devices 101, 103, 105 and may also be capable of text messaging. Such network devices include, for example, printers, scanners, facsimile machines, photocopiers, and multi-functional printers (MFPs) having a combination of at least two of the following functions: printing, scanning and facsimile. Some example MFPs are provided in U.S. patent application Ser. No. 11/187,645, titled “Method and System for Limiting Access to a Shared Network Device,” filed Jul. 22, 2005, the contents of which are hereby incorporated herein by reference in their entirety.

In certain other embodiments, the network may be connected to a larger text messaging network capable of SMS. In yet further embodiments, the electronic devices themselves may be connected to a different network, such as the public switch telephone network (“PTSN”). Electronic devices for use with such networks include cellular telephones, PDAs, landline telephones, and other wireless communication devices.

Shared Network Device

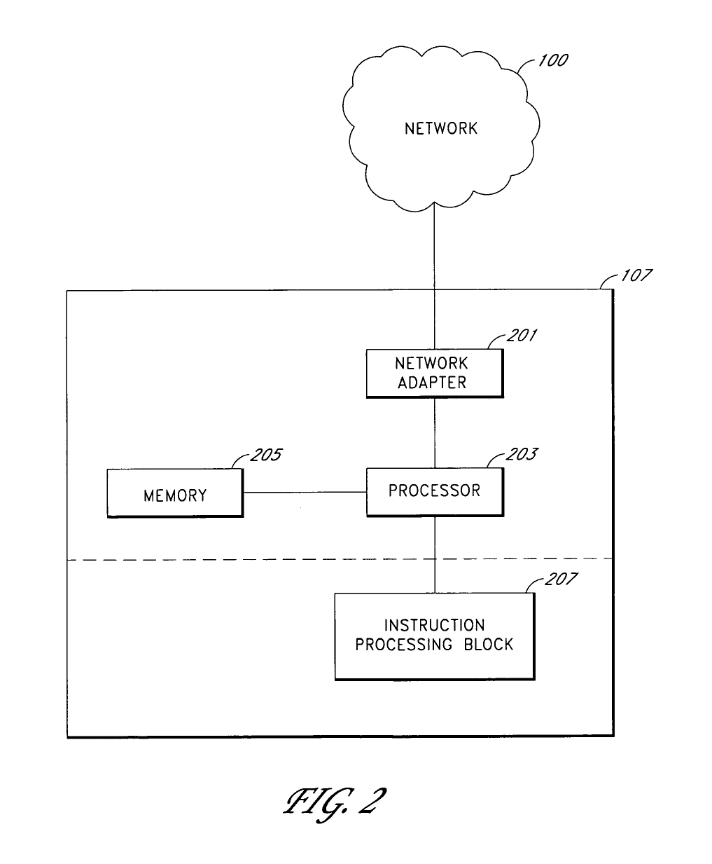

FIG. 2 illustrates a schematic block diagram of a network device such as a text-message capable MFP of an embodiment of the invention. The device 107 has a network adaptor 201 for providing an interface between the remaining components of the device 107 and the network 100 to which the device 107 is connected. The network adaptor 201 may have a wired or wireless connection to the network 100. Text messages may be sent through the network adaptor 201 to the network 100 where they may later be delivered to the appropriate destination. In the illustrated embodiment, the device 107 includes a processor 203, a memory 205, and an instruction processing block 207.

In the illustrated embodiment, the memory 205 stores identification information of the users who are authorized to access and use the device 107. In some embodiments, the memory is a rewritable memory or a read-only memory having pre-stored data and optionally programs, such as a program capable of creating and sending text messages. In one embodiment, the memory 205 is a non-volatile memory, such as a hard disk drive, a non-volatile random access memory (RAM), a flash memory, etc. In other embodiments, the memory 205 may be a volatile memory, in which each user's authorized identification information is stored at least while the device 107 is operating. In one embodiment of the volatile memory, the authorized identification information is copied to the memory 205 from another source when or soon after the device 107 is powered up.

The instruction processing block 207 is designed to process task instructions that are received from the network 100. Although not illustrated in detail, the instruction processing block 207 may include its own processor, memory, and other components. In some embodiments, the processor 203 and the processor of the block 207 may be implemented in a single chip or in separate chips. Also, the memory 205 and the memory of the block 207 may be implemented in a single memory device or as separate memory devices.

Keypad

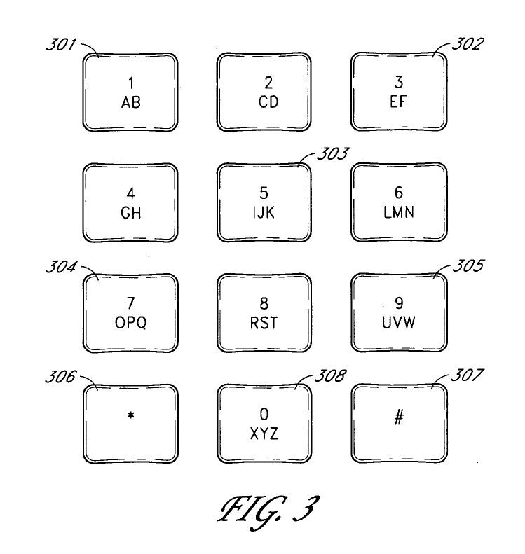

A keypad similar to the sample embodiment as shown in FIG. 3 may be made available on a MFP 107. The system to reduce key presses as discussed herein may be used with any number of electronic devices capable of text messaging. Common electronic devices that are capable of text messaging include, but are not limited to, mobile telephones, landline telephones, personal computers, MFPs, fax machines, personal digital assistants (“PDA”), and various other handheld communication devices.

According to the sample keypad as shown in FIG. 3, all numbered keys, keys “1” through “9,” are associated with letters. There are no more than three letters on any key, with several keys associated with only two letters. In the sample embodiment depicted, keys “*” 306 and “#” 307 are not associated with any indicium, although in certain other embodiments discussed herein keys “*” and “#” may be associated with selected indicium. Furthermore, as shown in FIG. 3, vowels are located in the corners and the center of the key arrangement and are the first characters on their respective keys; i.e., “A” on key “1” 301, “E” on key “3” 302, “I” on key “5” 303, “O” on key “7” 304, and “U” on key “9” 305.

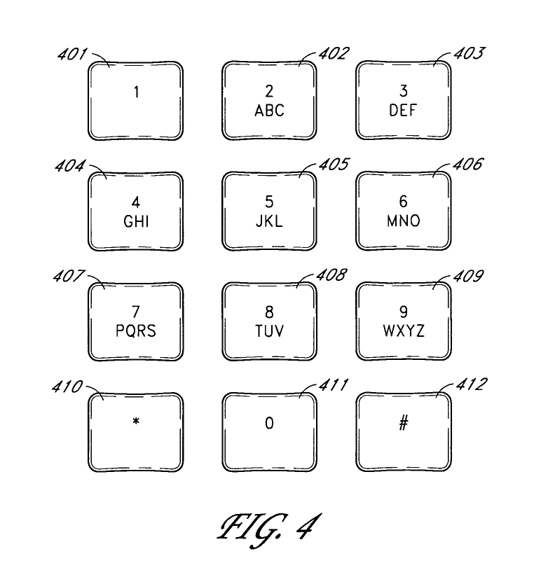

Prior art arrangements commonly use a numbered keypad as shown in FIG. 4. As can be seen in FIG. 4, keys “2” 402 through “9” 409 are associated with characters, and there are three to four characters on each of those keys. Keys “1” 401, “0” 411, “*” 410 and “#” 412 are not associated with characters. Furthermore, vowels are placed in different positions on their respective keys: “A” is the first character on key “2” 402, “E” is the second character on key “3” 403, “I” is the third character on key “4” 404, “O” is the third character on key “6” 406, and “U” is the second character on key “8” 408. Since vowels are usually later in the prior art arrangement, it takes longer to select a vowel for use in a text message. One feature of the system described herein, as shown in FIG. 3 and discussed above, places vowels as the first character on their respective keys 301-305. Consequently, in comparison to the prior art system, vowels may be more quickly selected.

In the system described, a character may be accessed by pressing a key in many different ways. In certain embodiments, a character may be accessed by pressing the key with which it is associated the number of times equaling the order of the character on they key. For example, in FIG. 3, key “0” 308 is associated with characters “X,” “Y” and “Z,” in that order. In order to access the character “Z,” the user would press the “0” key 308 three times since “Z” is the third character on the key. Another sample method of accessing a character associated with a key would be to hold down the key until the character is selected. A user may access any of the characters “X,” “Y,” and “Z,” by holding down the “0” key 308 until the character is selected. The length of the key press would govern which character is selected. Character “X” would be selected if the “0” key 308 is held for a brief period, character “Y” would be selected if the “0” key 308 is held for a longer period than for selecting character “X,” and character “Z” would be selected if the “0” key 308 is held for a longer period than for selecting “Y,” Yet another sample method of accessing a character associated with a key would be to press a combination of keys simultaneously. In some embodiments, pressing at least two keys simultaneously may also access a character not accessible by pressing a single key. For example, in FIG. 3, keys “1” 301 and “0” 308 may be configured to access the non-alphanumeric character ‘@’ if both keys “1” 301 and “0” 308 are pressed simultaneously. In certain embodiments, information regarding what characters may be accessed using combined key presses may be available on the keys. In certain other embodiments, information regarding what characters may be accessed using combined key presses may be available off of the keys, such that an association between the indicium and keys may still be inferred.

Certain embodiments of the system may also include features to address backwards compatibility with prior art systems. In the prior art, certain telephone numbers are published using the characters to which the keys are associated instead of the numbers themselves. For example, according to the prior art keypad as illustrated in FIG. 4, the underlying telephone number that is published as IMAGINE would be 462-4463 since “I” appears on key “4” 404, “M” appears on key “6” 406, and so on. In order to address this form of published telephone numbers, certain embodiments of the system may use the prior art character arrangement as a primary set accessible according to the prior art method, and use the enhanced character arrangement according to the system disclosed herein as a secondary set, accessible through entering a secondary mode. The secondary mode may be accessed in many different ways, including using a key, similar to a shift key in a calculator, or by accessing a touch screen. In certain other embodiments, the enhanced character arrangement may be accessed through a special text messaging mode on an electronic device which is separate from a dialing mode.

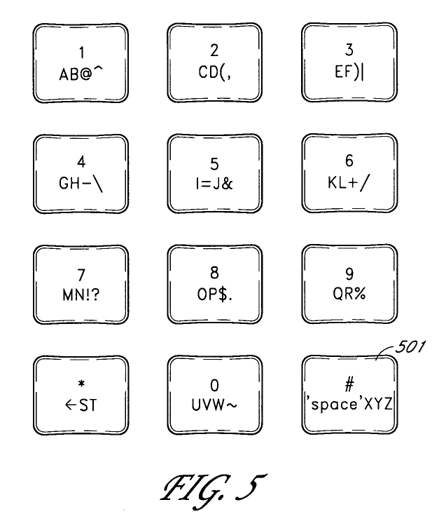

FIG. 5 shows an embodiment of the system using non-alphanumeric characters and keys available in addition to numbered keys. As shown in the embodiment, any variety of combinations of non-alphanumeric and alphanumeric characters may be used. Non-alphanumeric characters are selected for use preferably based on the estimated frequency of their use. For example, the non-alphanumeric character ‘space’ 501 may be selected for placement on the keypad because it is frequently used, such as between words. On the other hand, a non-alphanumeric character such as ‘§’ may not be selected for use with the keypad because it is not frequently used. Additionally, the characters are preferably ordered on the keys according to the estimated frequency of their use. For example, the non-alphanumeric character ‘space’ appears on key “#” 501 before the alphanumeric characters “X” “Y” and “Z” because the estimated frequency of use for ‘space’ is greater than the estimated frequency of use for “X” “Y” and “Z” in this sample embodiment.

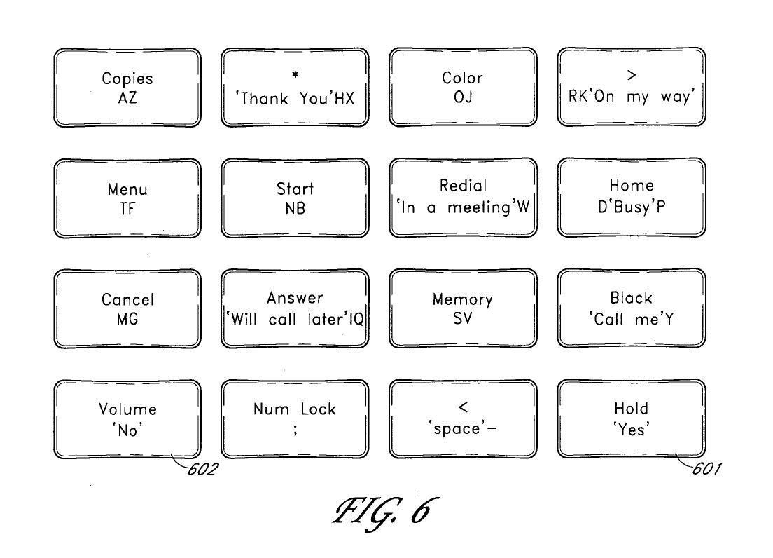

FIG. 6 shows an embodiment of the system where words, phrases and sentences are included on the keys in addition to alphanumeric characters for use with a multifunction fax machine keypad. As shown in the embodiment, any variety of combinations of words, phrases, sentences, and alphanumeric characters may be used. As with non-alphanumeric and alphanumeric characters, words, phrases, and sentences are selected for use preferably based on the estimated frequency of their use. For example, the word “Yes” 601 may be selected for placement on the keypad because it is frequently used, such as in a response to a question. On the other hand, a word such as “patent” may not be selected for use with the keypad because it is not frequently used. Additionally, the alphanumeric characters, words, phrases, and sentences are preferably ordered on the keys according to the estimated frequency of their use. For example, the word “No” appears on key “Volume” 602 first because the estimated frequency of use for “No” is greater than the estimated frequency of use for the other alphanumeric characters, words, phrases, or sentences on the “Volume” key in this sample embodiment.

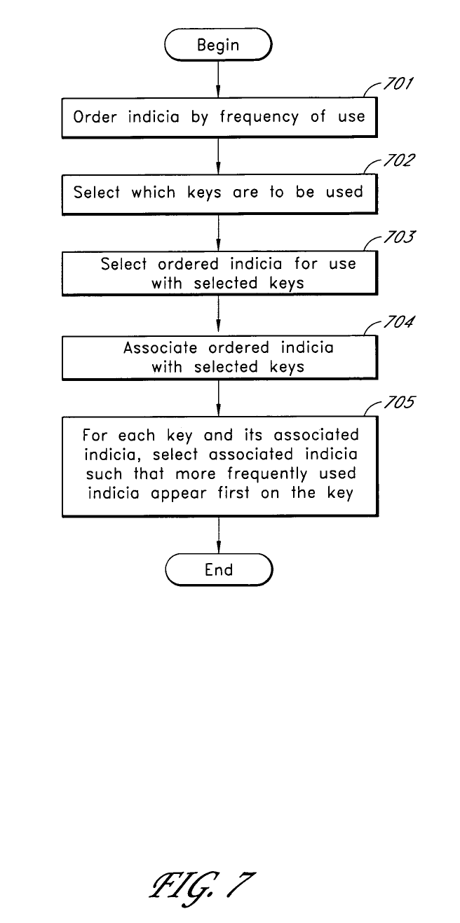

FIG. 7 is a flowchart of the selection of indicium for display in association with keys in accordance with one embodiment. Although FIG. 7 shows a sample flowchart for selecting commonly used indicia, other methods may be used. First, in step 701, characters, words, strings, phrases, sentences or other indicia are ranked by their frequency of use. Frequency of use may be determined in many ways, including but not limited to how many times the indicia are used in text messaging, everyday conversation, or in commons words or phrases. For example, in the English alphabet, more frequently used letters are ‘e’ ‘h’ and ‘t.’ Consequently, those three letters may appear high on the list of frequently used indicia, if the indicia are limited to English letters. Next, after creating a list of indicia ordered by the frequency of their use in step 701, in step 702 a set of keys are selected from the available keys on the electronic device for use with the system. All keys or any subset thereof may be selected for use. For example, in an MFP that has numeric keys for faxing capability in addition to non-numeric keys for other functionality, a subset of the keys, such as the numeric keys, may be selected for use with the indicia used for text messaging. In step 703, a subset of the list of frequently used indicia created in step 701 is selected for use with the keys selected in step 702. It is preferable to select the number of available keys in step 702 before selecting the number of indicia for use with those keys in step 703 because the number of keys available can have an affect on the number of indicia selected for use. For example, if only nine keys are selected in step 702, then it may not be advisable to select 100 indicia in step 703 because too many indicia would be associated with a single key. Alternatively, if, for example, all the letters of the English alphabet were ordered by frequency of use in step 701, and all were then selected for use in step 703 for use with numeric keys available on an MFP as discussed in step 702, then there would be 26 characters available for use with 10 keys. In step 704, the indicia selected in step 703 are associated with the keys selected in step 702. Indicia may be selected for association with keys according to many different methods. One example method is to pick is to assign a different key to each consecutive indicia on the list of selected indicia from step 703, and cycle through the keys in order until all indicia are assigned keys. For example, if the selected indicia in order of popularity were ‘A’ ‘B’ ‘C’ ‘D’ ‘E’ and ‘F,’ and keys ‘1’ and ‘2’ were selected for use, then ‘A’ would be assigned to ‘1,’ then ‘B’ would be assigned to key ‘2,’ ‘C’ to key ‘1,’ ‘D’ to key ‘2,’ E to key ‘1’ and ‘F’ to key ‘2,’ In this way, each key would have a similar number of high frequency indicia and low frequency indicia. Then in step 705, indicia associated with each key would be prioritized according to their frequency. Thus, from the example of step 704, key ‘1’ would be associated with ‘A’ ‘C’ and ‘E’ in that order, and key ‘2’ would be assigned ‘B’ ‘D’ and ‘F’ in that order, since ‘A’ is more popular than ‘C’ which is more popular than ‘E’ in the example given.

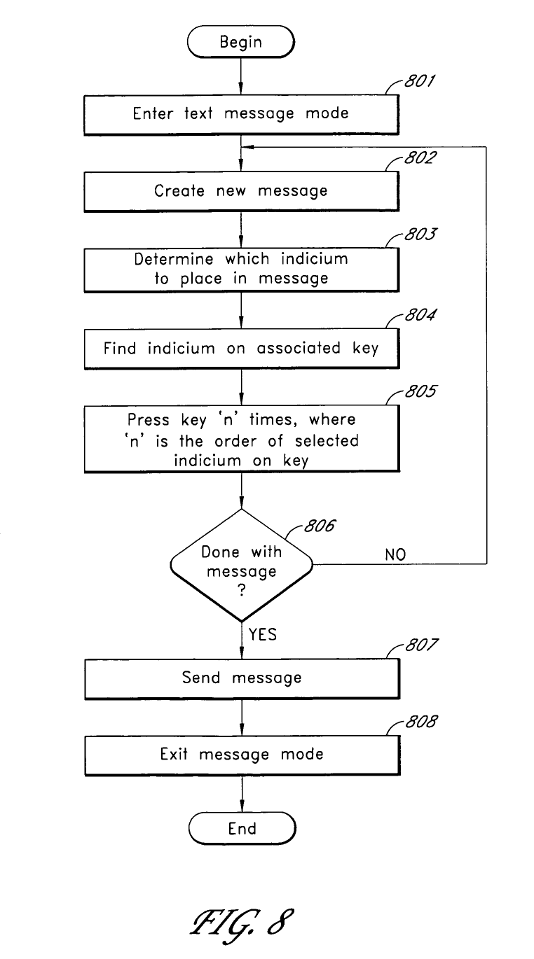

FIG. 8 is a flowchart of how a text message may be sent in accordance with one embodiment. According to certain embodiments, the first step 801 in sending a text message is to enter the text messaging mode of the electronic device. After entering into the text messaging mode, the option for creating a new message should be selected 802. After selecting to create a new message, a user must determine which indicium to place in the message in step 803. The indicium must then be located on a key in step 804, advantageously ordered on the key according to its frequency of use. The indicium is then selected in step 805 according to certain embodiments by pressing the key the same number of times equaling the order of the indicium on the key, as described above. If the message is not yet complete 806, the user may enter another key by returning to step 803. Otherwise, after all indicia have been selected for use in the text message 806, then the message is sent 807. After the message is sent, the messaging mode may be exited 808.

It will be appreciated by those skilled in the art that the above-described system may be straightforwardly adapted or extended in various ways. While the foregoing description makes reference to particular embodiments, the scope of the invention is defined solely by the claims that follow and the elements recited therein.

What is claimed is:

1. A system for creating text messages, comprising:
an electronic device configured for text message use;
a plurality of indicia used to create a text message on the electronic device;
a plurality of keys located on the electronic device and associated with the plurality of indicia, wherein the indicia located on the keys are arranged in part according to the frequency of use of the indicia on the key;
an indicium selection feature, where the indicium is selected by pressing at least one key with which it is associated the number of times matching the order with which the indicium appears on the at least one key; and
a message sending feature available on the electronic device, where the message created by the selection of the at least one indicium is sent.

2. The system of claim 1, wherein the indicia are letters.

3. The system of claim 1, wherein the indicia comprise characters, words, phrases, and sentences.

4. The system of claim 1, wherein if a vowel appears on the at least one key, then the vowel is the first indicium on the key.

5. The system of claim 1, wherein the electronic device is a cellular telephone.

6. The system of claim 1, wherein the electronic device is a multi-functional printer.

7. The system of claim 1, wherein the at least one key has a function in addition to use with the at least one indicium.

8. A system for creating messages, comprising:
a plurality of indicia used to create a message;
a plurality of keys associated with the plurality of indicia, wherein at least one indicium is associated with at least one key according to the at least one indicium's estimated frequency of use,
an indicium selection feature, where the at least one indicium is selected by pressing the at least one key with which the at least one indicium is associated in a manner reflective of the order with which the at least one indicium appears on the at least one key.

9. The system of claim 8, wherein the at least one indicium is selected by pressing the at least one key with which the at least one indicium is associated the number of times matching the order with which the at least one indicium appears on the at least one key.

10. The system of claim 8, wherein the at least one indicium is selected by holding the at least one key with which the at least one indicium is associated for a duration reflecting the order with which the at least one indicium appears on the at least one key.

11. The system of claim 8, wherein the indicia are letters.

12. The system of claim 8, wherein the indicia comprise characters, words, phrases, and sentences.

13. The system of claim 8, wherein if a vowel appears on the at least one key, then the vowel is the first indicium on the key.

14. The system of claim 8, wherein the at least one key has a function in addition to use with the at least one indicium.

15. The system of claim 8, further comprising an electronic device configured for text message use.

16. The system of claim 15, wherein the electronic device is a cellular telephone.

17. A method of sending messages, comprising:
creating a message with at least one key, wherein at least one indicium used to create the message is associated with the at least one key according to the estimated frequency of usage;
selecting the at least one indicium by pressing the at least one key with which it is associated the number of times matching the order with which the at least one indicium appears on the at least one key; and
sending the message.

18. The method of claim 17, wherein the at least one indicium is a letter.

19. The system of claim 17, wherein the at least one indicium comprises a character, a word, a phrase, and a sentence.

20. The method of claim 17, wherein the at least one key has a function in addition to use with the at least one indicium.

21. A method of reducing the number of key presses for sending messages comprising:
determining at least one indicium to place on a selected one of a plurality of keys; and
arranging the at least one indicium on the selected key according to the frequency with which the at least one indicium is estimated to be used to create a text message.

22. The method of claim 21, wherein the at least one key has a function in addition to use with the at least one indicium.

23. The method of claim 21, wherein the at least one indicium comprises a character, a word, a phrase, and a sentence.

24. The method of claim 21, wherein if a vowel appears on the at least one key, then the vowel is the first indicium on the key.

25. The method of claim 21, wherein the electronic device is a multi-functional printer.

26. A system for sending messages, comprising:
means for associating at least one indicium with at least one key, wherein the at least one indicium is associated with the at least one key according to the at least one indicium's estimated frequency of use,
means for selecting the at least one indicium to use in a message; and
means for sending a message comprised of the at least one indicium selected by pressing the at least one key.
